(19) United States
(12) Patent Application Publication
(10) Pub. No.: US 2012/0124815 A1
(43) Pub. Date: May 24, 2012

(54) WIRE HARNESS ARRANGEMENT METHOD

(75) Inventors: Miyoshi MABUCHI, Makinohara-shi (JP); Akiyuki HIRATA, Makinohara-shi (JP)

(73) Assignee: YAZAKI CORPORATION, Tokyo (JP)

(21) Appl. No.: 13/301,185

(22) Filed: Nov. 21, 2011

(30) Foreign Application Priority Data
Nov. 24, 2010 (JP) 2010-261256

(51) Int. Cl. B23P 17/00

(52) U.S. Cl. 29/525.01

(57) ABSTRACT

A wire harness arrangement method for fixing a wire bundle including a plurality of wires constituting a wire harness to a wire harness arrangement path on a vehicle body panel with a plurality of clamp members is provided. A position of a clamp attachment hole to be formed on the vehicle body panel is set such that a separation distance that is equal to or larger than a first predetermined dimension is remained between an edge portion of the vehicle body panel at a side of the wire harness arrangement path and the wire bundle held by the clamp members. An installation interval of the clamp members is set such that a swing width of the wire bundle suspended between the clamp members adjacent to each other due to vibration of a vehicle body is smaller than the first predetermined dimension.

The disclosure of Japanese Patent Application No. 2010-261256 filed on Nov. 24, 2010, including specification, drawings and claims is incorporated herein by reference in its entirety.

### BACKGROUND

The invention relates to a wire harness arrangement method for fixing a bundle of wires constituting a wire harness to a wire harness arrangement path on a vehicle body panel with a plurality of clamp members.

FIG. 3 illustrates a wire harness arrangement method according to the related art. In the wire harness arrangement method, a wire bundle 103 including a plurality of wires constituting a wire harness 101 is fixed to a wire harness arrangement path on a vehicle body panel 121 with a plurality of clamp members 111.

The vehicle body panel 121 of the illustrated example has a plurality of edge portions E1, E2, E3 . . . around the wire harness arrangement path. The edge portions E1, E2, E3 . . . are punching press parts of a metal plate and include a burr or the like that may cause damage to the wires when they are in contact with the wires.

Accordingly, in the wire harness arrangement method according to the related art, there is provided a protection member 105 covering the wire bundle 103 at portions of the wire bundle 103 that are liable to be in contact with the edge portions E1, E2, E3 . . . to avoid a direct contact between the wire bundle 103 and the edge portions.

FIG. 4 illustrates a wire harness on which the protection member 105 is mounted according to the related art (see, e.g., Patent Document 1).

The protection member 105 is a spiral tube wound on the outer periphery of the wire bundle 103 constituting the wire harness.

Further, there has been proposed a wire harness using a cylindrical protector as the protection member 105 (see, e.g., Patent Document 2).

Patent Document 1: JP-A-2001-239900

Patent Document 2: JP-A-7-143647

However, in the technologies disclosed in Patent Documents 1 and 2, the spiral tube or protector covering the wire bundle 103 caused a problem such as the large size and heavy weight of the wire harness.

Further, the spiral tube or protector may interfere with the vehicle body panel due to vibration or the like when driving a vehicle, thereby causing a problem such as occurrence of unusual sound or damage.

### SUMMARY

It is therefore an object of the present invention to provide a wire harness arrangement method capable of achieving the small size and light weight of a wire harness by reducing the number of components, and preventing occurrence of unusual sound or damage of wires constituting the wire harness due to interference between the wires and a vehicle body panel.

The object of the present invention can be achieved by the following configurations of (1) and (2).

(1) A wire harness arrangement method for fixing a wire bundle including a plurality of wires constituting a wire harness to a wire harness arrangement path on a vehicle body panel with a plurality of clamp members, the wire harness arrangement method comprising: setting a position of a clamp attachment hole formed on the vehicle body panel such that a separation distance that is equal to or larger than a first predetermined dimension is remained between an edge portion of the vehicle body panel at a side of the wire harness arrangement path and the wire bundle held by the clamp members; and setting an installation interval of the clamp members such that a swing width of the wire bundle suspended between the clamp members adjacent to each other due to vibration of a vehicle body is smaller than the first predetermined dimension.

(2) The wire harness arrangement method according to (1), wherein each of the wires of the wire bundle suspended between the clamp members so as to make a curved shape, wherein a bending radius of a wire at an inner peripheral side of the curved shape is greater than a bending radius of a wire at an outer peripheral side of the curved shape such that a gap having substantially a crescent shape is formed between the wire at the inner peripheral side and the wire at the outer peripheral side, and wherein the wire at the inner peripheral side and the wire at the outer peripheral side are fixed to each other at both ends of the curved shape.

By the configuration of (1), the wire harness arranged on the vehicle body panel is arranged in non-contact with the edge portions on the side of the vehicle body panel by setting the position of the clamp attachment hole to which each of the clamp members is attached, or setting the installation interval between the clamp members.

Accordingly, there is no need to mount a protection member such as a spiral tube or protector to protect the wires constituting the wire harness from the edge portions.

Thus, as compared to the wire harness arrangement method according to the related art in which the protection member is mounted to protect the wire bundle from the edge portions, it is possible to achieve the small size and light weight of the wire harness by omitting the protection member.

Further, since the wire harness is arranged to be in non-contact with the vehicle body panel even though vibration or the like occurs when driving a vehicle, it is possible to avoid interference between the wires constituting the wire harness and the vehicle body panel. As a result, it is possible to prevent occurrence of unusual sound or damage of the wires constituting the wire harness due to interference between the wires and the vehicle body panel.

Further, by the configuration of (2), when, e.g., an external force for restoring the curve of the wire bundle is exerted on the wire bundle suspended in a curved shape between the clamp members, a tensile load is applied to the wire of the inner peripheral side and a compressive load is applied to the wire of the outer peripheral side. Further, when an external force for increasing the curve of the wire bundle is exerted on the wire bundle, a compressive load is applied to the wire of the inner peripheral side and a tensile load is applied to the wire of the outer peripheral side. That is, when an external force for changing the curved shape of the wire bundle is exerted on the wire bundle, loads are applied in opposite directions to the wire of the inner peripheral side and the wire of the outer peripheral side, thereby providing an effect of suppressing a change in the curved shape to each other.

Further, in the configuration in which the gap having substantially a crescent shape is formed between the wire of the inner peripheral side and the wire of the outer peripheral side, the effect of suppressing a change in the curved shape is strongly applied to each other, thereby preventing a change in the curved shape of the wire bundle.

Accordingly, it is possible to surely prevent the wire bundle suspended in a curved shape between the clamp members from being in contact with the edge portions on the side of the vehicle body panel due to a change in the curved shape.

In the wire harness arrangement method according to the invention, the wire harness arranged on the vehicle body panel is arranged in non-contact with the edge portions on the side of the vehicle body panel by setting the position of the clamp attachment hole to which each of the clamp members is attached, or setting the installation interval between the clamp members.

Accordingly, there is no need to mount a protection member such as a spiral tube or protector to protect the wires constituting the wire harness from the edge portions.

Thus, as compared to the wire harness arrangement method according to the related art in which the protection member is mounted to protect the wire bundle from the edge portions, it is possible to achieve the small size and light weight of the wire harness by omitting the protection member.

Further, since the wire harness is arranged to be in non-contact with the vehicle body panel even though vibration or the like occurs when driving a vehicle, it is possible to avoid interference between the wires constituting the wire harness and the vehicle body panel. As a result, it is possible to prevent occurrence of unusual sound or damage of the wires constituting the wire harness due to interference between the wires and the vehicle body panel.

### BRIEF DESCRIPTION OF THE DRAWINGS

In the accompanying drawings:

FIG. 1 schematically shows a configuration of a wire harness that is arranged by a wire harness arrangement method according to an embodiment of the invention;

FIG. 2 is an explanatory diagram of a supporting method of a wire bundle suspended in a curved shape between clamp members in the wire harness shown in FIG. 1;

FIG. 3 schematically shows a configuration of a wire harness that is arranged by a wire harness arrangement method according to the related art; and

FIG. 4 is an explanatory diagram showing an example of a protection member shown in FIG. 3.

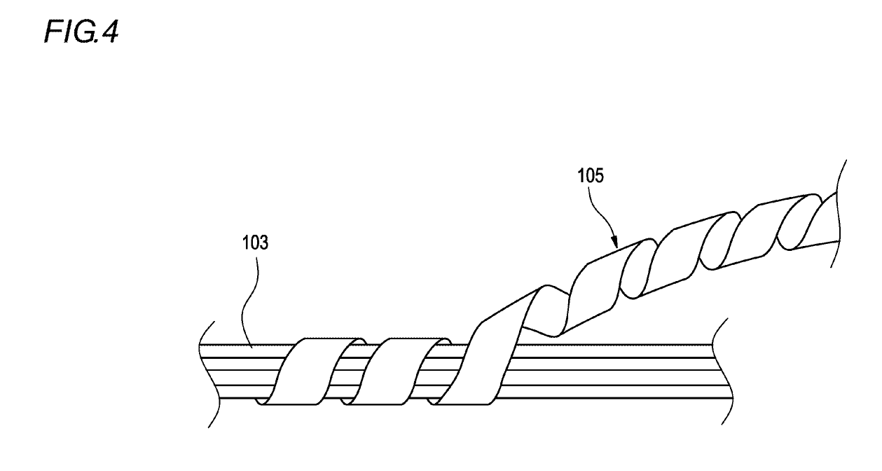

### DETAILED DESCRIPTION OF THE EMBODIMENTS

Hereinafter, a wire harness arrangement method according to an embodiment of the invention will be described in detail with reference to the accompanying drawings.

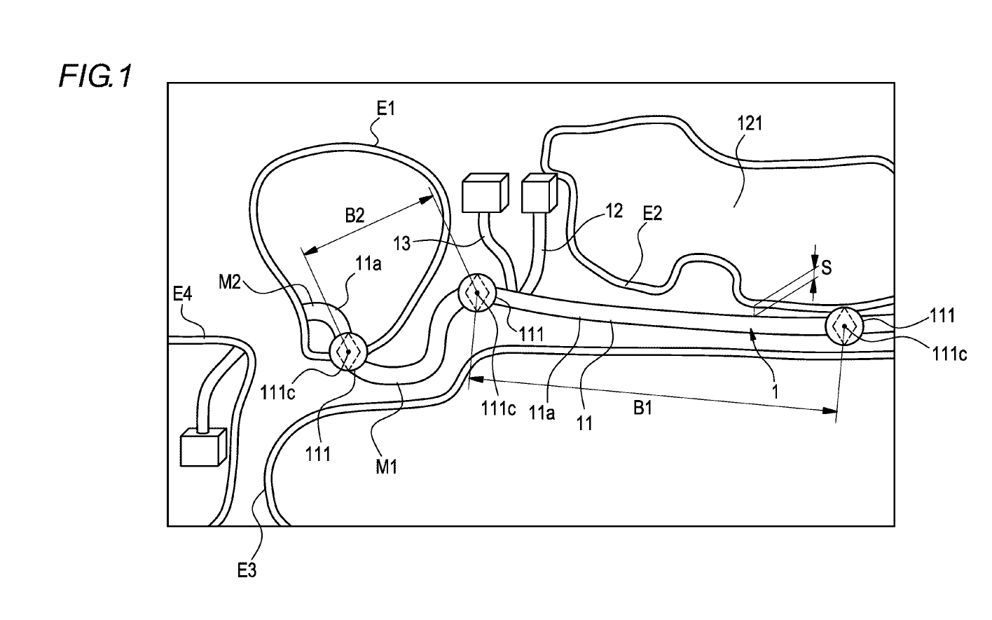

FIG. 1 schematically shows a configuration of a wire harness that is arranged by the wire harness arrangement method according to the embodiment of the invention.

A wire harness 1 which is arranged by the wire harness arrangement method of this embodiment includes a main trunk 11 from which branches 12 and 13 extend.

Each of the main trunk 11 and the branches 12 and 13 is arranged in a state where a bundle of wires is directly bound by an adhesive tape or binding band without being contained in a protection member such as a tube made of resin.

In the wire harness arrangement method of this embodiment, a wire bundle 11a including a plurality of wires constituting the main trunk 11 of the wire harness 1 is fixed to a wire harness arrangement path on a vehicle body panel 121 by a plurality of clamp members 111.

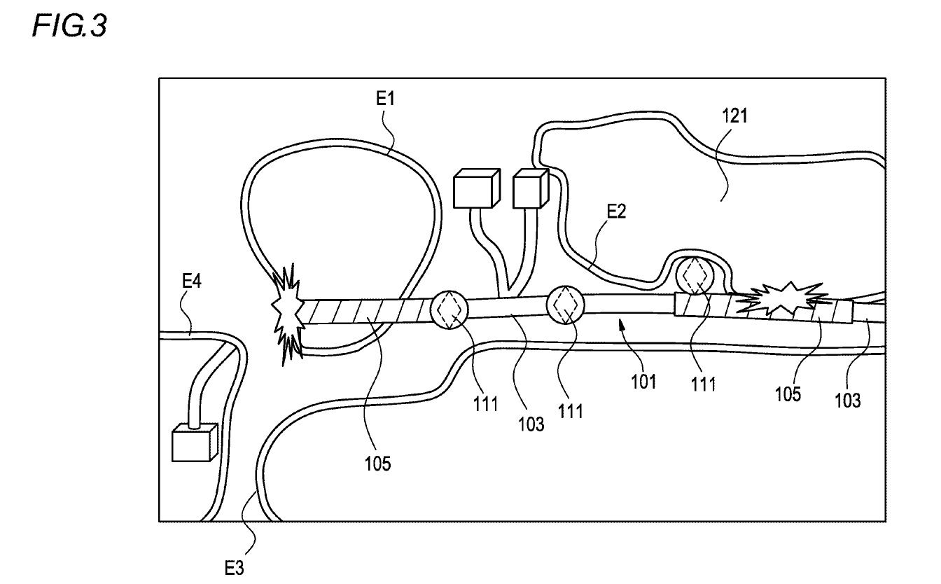

The vehicle body panel 121 illustrated in FIG. 1 is the same as that illustrated in FIG. 3, and has a plurality of edge portions E1, E2, E3 . . . around the wire harness arrangement path. The edge portions E1, E2, E3 . . . are punching press parts of a metal plate and include a burr or the like that may cause damage to the wires when they are in contact with the wires.

Each of the clamp members 111 is fixed to a clamp attachment hole (not shown) formed in the wire harness arrangement path of the vehicle body panel 121. Although not shown in the drawings, the clamp attachment hole is formed at a position facing a center 111c of each of the clamp members 111. In the wire harness arrangement method of this embodiment, a position of the clamp attachment hole formed at a position facing the center 111c of each of the clamp members 111 is set such that a separation distance S is remained between the wire bundle 11a held by the clamp members 111 and the edge portions E1, E2, E3 . . . of the vehicle body panel 121 at a side of the wire harness arrangement path. In this case, the separation distance S is set to be equal to or larger than a first predetermined dimension.

Further, in the wire harness arrangement method of this embodiment, an installation interval B1, B2 of the clamp members 111 as a separation distance of the adjacent clamp members 111 is set such that a swing width of the wire bundle 11a suspended between the adjacent clamp members 111 due to vibration of a vehicle body or the like is smaller than the first predetermined dimension.

Accordingly, the wire bundle 11a suspended by the clamp members 111 along the wire harness arrangement path is arranged such that the wire bundle 11a is not contact with the edge portions E1, E2, E3 . . . on the side of the vehicle body panel 121.

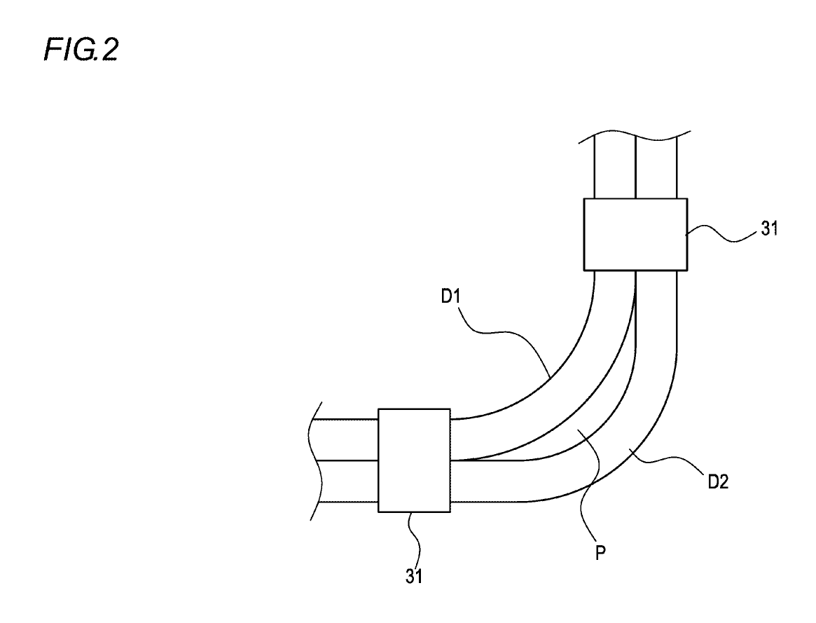

Further, in the wire harness arrangement method of this embodiment, in bent portions M1 and M2 of the wire bundle 11a suspended between the clamp members 111 so as to make a curved shape, each of the wires is supported as illustrated in FIG. 2.

In a supporting structure of FIG. 2, a bending radius of a wire D1 at an inner peripheral side of the curved shape is greater than a bending radius of a wire D2 at an outer peripheral side such that a gap P having substantially a crescent shape is formed between the wire D1 at the inner peripheral side and the wire D2 at the outer peripheral side.

Further, in the supporting structure of FIG. 2, the wire D1 at the inner peripheral side and the wire D2 at the outer peripheral side are fixed to each other with fixing means 31 at both ends of the curved shape.

The fixing means 31 may be configured by tape winding using an adhesive tape, welding between outer insulating covers of the wires D1 and D2, adhesion using an adhesive or the like.

In the wire harness arrangement method of the above-described embodiment, the main trunk (wire harness) 11 arranged on the vehicle body panel 121 is arranged in non-contact with the edge portions E1, E2, E3 . . . on the side of the vehicle body panel 121 by setting the position of the clamp attachment hole to which each of the clamp members 111 is attached, or setting the installation interval between the clamp members 111.

Accordingly, there is no need to mount a protection member, such as a spiral tube or protector for protecting the wires from the edge portions E1, E2, E3 . . . , on the wires constituting the main trunk 11.

Thus, as compared to the wire harness arrangement method according to the related art in which the protection member is mounted to protect the wire bundle from the edge portions, it is possible to achieve the small size and light weight of the wire harness by omitting the protection member.

Further, since the main trunk 11 is arranged to be in non-contact with the vehicle body panel 121 (the edge portions E1, E2, E3 . . . ) even though vibration or the like occurs when driving a vehicle, it is possible to avoid interference between the wires constituting the wire harness and the vehicle body panel 121. As a result, it is possible to prevent occurrence of unusual sound or damage of the wires constituting the wire harness due to interference between the wires and the vehicle body panel 121.

Further, in the wire harness arrangement method of the above-described embodiment, when, e.g., an external force for restoring the curve of the wire bundle 11a is exerted on the wire bundle 11a suspended in a curved shape between the clamp members 111, a tensile load is applied to the wire D1 at the inner peripheral side and a compressive load is applied to the wire D2 at the outer peripheral side. Further, when an external force for increasing the curve of the wire bundle 11a is exerted on the wire bundle 11a, a compressive load is applied to the wire D1 at the inner peripheral side and a tensile load is applied to the wire D2 at the outer peripheral side. That is, when an external force for changing the curved shape of the wire bundle 11a is exerted on the wire bundle 11a, loads are applied in opposite directions to the wire D1 at the inner peripheral side and the wire D2 at the outer peripheral side, thereby providing an effect of suppressing a change in the curved shape to each other.

Further, in the configuration in which the gap P having substantially a crescent shape is formed between the wire D1 at the inner peripheral side and the wire D2 at the outer peripheral side as shown in FIG. 2, the effect of suppressing a change in the curved shape is strongly applied to each other, thereby preventing a change in the curved shape of the wire bundle 11a.

Accordingly, it is possible to surely prevent the wire bundle 11a suspended in a curved shape between the clamp members 111 from being in contact with the edge portions E1, E2, E3 . . . on the side of the vehicle body panel 121 due to a change in the curved shape.

The invention is not limited to the above-described embodiment, and appropriate modification and improvement and the like can be made. Further, in the above-described embodiments, no limitation is imposed on the material, shape, dimension, value, form, number, installation position and the like of each of the components if the invention can be achieved.

1. A wire harness arrangement method for fixing a wire bundle including a plurality of wires constituting a wire harness to a wire harness arrangement path on a vehicle body panel with a plurality of clamp members, the wire harness arrangement method comprising:
setting a position of a clamp attachment hole formed on the vehicle body panel such that a separation distance that is equal to or larger than a first predetermined dimension is remained between an edge portion of the vehicle body panel at a side of the wire harness arrangement path and the wire bundle held by the clamp members; and
setting an installation interval of the clamp members such that a swing width of the wire bundle suspended between the clamp members adjacent to each other due to vibration of a vehicle body is smaller than the first predetermined dimension.

2. The wire harness arrangement method according to claim 1,
wherein each of the wires of the wire bundle is suspended between the clamp members so as to make a curved shape,
wherein a bending radius of a wire at an inner peripheral side of the curved shape is greater than a bending radius of a wire at an outer peripheral side of the curved shape such that a gap having substantially a crescent shape is formed between the wire at the inner peripheral side and the wire at the outer peripheral side, and
wherein the wire at the inner peripheral side and the wire at the outer peripheral side are fixed to each other at both ends of the curved shape.
